(19) United States
(12) Patent Application Publication
(10) Pub. No.: US 2020/0286186 A1
(43) Pub. Date: Sep. 10, 2020

(54) Work Zone Traceability

(71) Applicant: Christopher Duane Clapper, Binghamton, NY (US)

(72) Inventor: Christopher Duane Clapper, Binghamton, NY (US)

(73) Assignee: Imperative Solutions LLC, Binghamton, NY (US)

(21) Appl. No.: 16/294,275

(22) Filed: Mar. 6, 2019

(51) Int. Cl. G06Q 50/04; G06Q 10/08

(52) U.S. Cl. CPC G06Q 50/04; G06Q 10/087

(57) ABSTRACT

The invention is the process of tracking and collecting components and process parameters from a plurality of devices used to build product between two or more predefined data points as one operation (i.e. work zone). The data points defined within the work zone are used to identify each article of work and its lifecycle within the work zone using a unique identifier for each unit produced. Information collected from the devices or operations defined between the work zone data points is collected by the system as one operation.

### CROSS REFERENCE TO RELATED APPLICATIONS

PPA 62/641,901

### FEDERALLY SPONSORED RESEARCH

N/A

### SEQUENCE LISTING

N/A

### BACKGROUND

This method is an ideal solution for many customers who may tolerate broadening the scope of a traceability recall pending product traceabiiity requirements. A good example of an application for work zone traceability would be a consumer lighting product where a field recall of a slightly broader range of serial Id's is an acceptable application. A questionable application for work zone traceability may be implanted medical devices, these applications often require traceability definitive to each device or operation for every unit produced.

### DETAILED DESCRIPTION

A work zone must first be defined by an application hosting work zone traceability. A work zone consists of two data points within the customers process where the serial Id from each work article is collected and processed.

Work zone attribute data is collected from the devices between the work zone start and end data points defined in the previous step. Work zone attribute data is produced by a plurality of devices, persons and/or operations to be performed within the work zone of which participates in the articles build process (e.g. serialized materials and process parameters). The Work zone application monitors all attribute data within the work zone for changes throughout the course of the build process.

Each work article ID at the start of a work zone is paired to the work article ID at the end of the work zone using its unique article ID. The work articles ID is associated with the work zone attribute data in use for each work zone by the work zone application.

### ADVANTAGES

Work Zone Traceabiilty allows a customer to lower the cost and complexity of additional hardware and the burden of complex process operations in collecting the unique assembly identifier from every device in the process.

### APPLICATION REQUIREMENTS

1. The user must define a start and end data point within their process known as the “work zone”. The said data points define locations within the process where a unique identifier for each article of work is collected and processed by the work zone application.

2. The Work Order Attributes, i.e. material and/or process parameters are collected and identified by the work zone application prior to and during the build process.

### OPERATION

1) Data from the work zone attributes used to construct each article of work is collected from the processing stations within the work zone

2) The work article identifier is collected from the first data point in the work zone know as the work zone start.

3) The work zone application actively maintains any changes administered to the work zone attributes, e.g. part changes, process parameters, etc. relative to all process stations within the work zone as defined between work zone data points.

4) The article of work completes the build process after reaching the last station in the work zone, defined as the work zone end.

5) The work zone application pairs the identifier for the article of work from the work zone end to the identifier from the work zone start to eliminate any potential deviation in the FIFO queue.

6) The article of work's life cycle within the work zone is used to associate the article's identifier to the Work Zone Attribute data as collected in process step 3.

7) This cycle is repeated for steps 2-6 above for each work article and processing station defined per work zone within the process.

### RESULT

Articles of work may be identified using the unit's serial id in relation to the work order attributes collected from the steps within the work zone process without tracking each article of work throughout the work zone operations, i.e. work zone traceability.

### SUMMARY

The result allows the user to search by work zone attribute identifiers or work article identifiers and return a range or information relative to the work zone attribute data used to assemble each work article.

### DRAWINGS

FIG. 1 illustrates the application layout of a plurality of manufacturing devices within a processing system used collectively to build a product and collect data within a work zone. Materials and process parameters are registered prior to and during the production run. The work articles, i.e. articles of work are scanned at the start and end of the Work Zone.

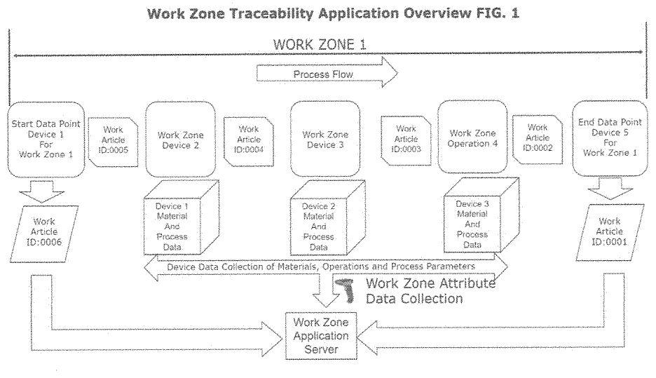

FIG. 2 Sequence diagram illustrates a logical process flow for processing a unique Work Article ID within a Work Zone application. The work article id's are entered into a software queue at the start of the work zone and paired to the system attribute data at the end of the work zone. This process continues for subsequent work zones until the assembly process is complete.

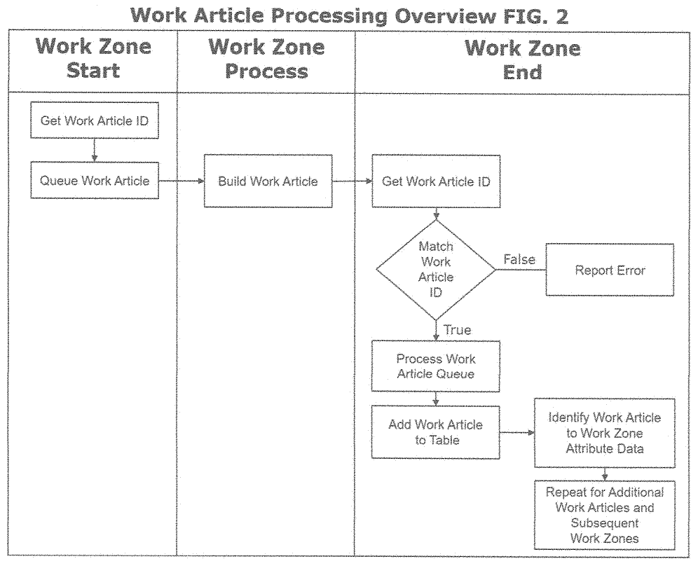

FIG. 3 illustrates the granularity of work zone traceability by highlighting a part change that occurs after processing work article 0002 on device 4 in the applicable work zone. The application identifies all materials exposed to each work article during the build process between the work zone data points regardless of their application to the work article. This is especially true for work articles in process during a change of parameters or materials during the build process. The objective is to provide a complete result for all articles of work built relative to the work zone attributes in question.

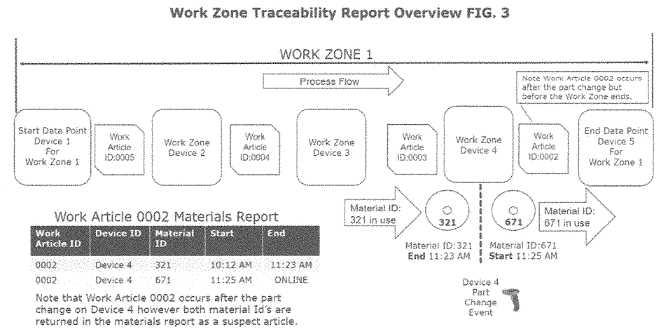

FIG. 4 illustrates how multiple work zones can be setup in a factory to collect product information from various data points or work centers within the customers process.

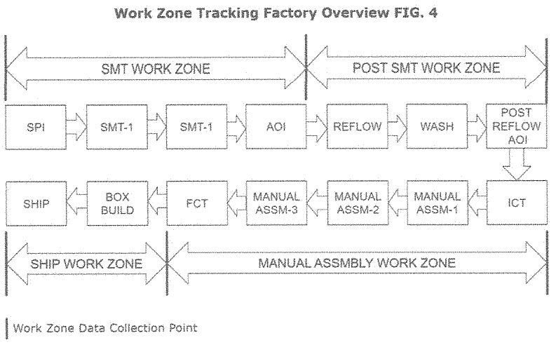

What is claimed is:

1) A method to gather attribute data for subcomponents and parameters between two or more points from a system whereby an article of work is assembled through a plurality of devices whereas an attribute unique to the article of work is used to identify its lifecycle and the attributes in use between said data points.

2) A system according to claim 1, uses the value of an assembly's unique identifier assigned to the article of work to associate materials and parameters in use between two or more data points.
